(19) United States
(12) Patent Application Publication
(10) Pub. No.: US 2008/0245590 A1
(43) Pub. Date: Oct. 9, 2008

(54) Hybrid Automotive Vehicle with Thermoelectric Device

(75) Inventors: Serdar H. Yonak, Ann Arbor, MI (US); Mustafa U. Demirci, Ann Arbor, MI (US)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Engineering & Manufacturing North America, Inc., Erlanger, KY (US)

(21) Appl. No.: 11/696,761

(22) Filed: Apr. 5, 2007

(51) Int. Cl. B60K 6/00

(52) U.S. Cl. 180/165

(57) ABSTRACT

An automotive vehicle, such as an HEV, having an internal combustion engine and an electrical system. A thermoelectric device overlies the internal combustion engine and converts heat from the engine into electricity. The thermoelectric device is electrically coupled to the electrical system of the vehicle.

### BACKGROUND OF THE INVENTION

I. Field of the Invention

The present invention relates generally to hybrid automotive vehicles and, more particularly, to such a vehicle with a thermoelectric device for capturing waste heat and converting the waste heat into electricity.

II. Description of Related Art

Hybrid automotive vehicles include both an electric motor as well as an internal combustion engine to propel the vehicle. In some driving situations, the electric motor is utilized to propel the vehicle while, conversely, in other driving situations the internal combustion engine propels the vehicle.

Hybrid electric vehicles are enjoying increased popularity due to their high efficiency. For example, since the electric motor propels the vehicle during certain driving situations, such hybrid electric vehicles consume less combustible fuels than the previously known automotive vehicles which relied solely upon an internal combustion engine as the propulsion source.

Although hybrid electric vehicles enjoy enhanced efficiency as compared to automotive vehicles using only an internal combustion engine as the propulsion source, even hybrid automotive vehicles suffer from certain inefficiencies. For example, the internal combustion engine for the hybrid automotive vehicle, when in use to propel the vehicle, generates a relatively large amount of heat as a byproduct of the combustion process. Such heat is typically expelled to the atmosphere not only through the exhaust system of the automotive vehicle, but also through radiation and convection outwardly from the internal combustion engine.

### SUMMARY OF THE PRESENT INVENTION

The present invention provides a hybrid automotive vehicle with a thermoelectric device which overcomes the above-mentioned disadvantages of the previously known vehicles.

In brief, the hybrid vehicle of the present invention comprises an internal combustion engine as well as an electrical system. This electrical system not only controls the operation of the internal combustion engine for the hybrid vehicle as well as an electric motor also used to propel the vehicle, but also all of the other electrical systems of the vehicle.

A thermoelectric device is positioned within the vehicle so that the thermoelectric device overlies and optionally encapsulates at least a portion of the internal combustion engine. In one embodiment, a hood overlaps the internal combustion engine and the thermoelectric device is mounted to the hood.

The thermoelectric device may comprise any device which converts heat energy into electrical energy. For example, the thermoelectric device may comprise one or more semiconductor thermophotovoltaic cells arranged in a panel which overlies the internal combustion engine. Alternatively, the thermoelectric device may comprise one or more thermocouples which overlie the internal combustion engine.

The thermoelectric device converts the heat energy from the internal combustion engine into electricity which is electrically connected to the electrical system for the vehicle. This electrical system may comprise, for example, an electrical energy storage device, such as a battery or fuel cell. Similarly, the electrical device may comprise the electric motor used to propel the vehicle during certain driving situations.

Optionally, a portion of the thermoelectric device is positioned adjacent the exhaust system of the automotive vehicle and/or adjacent other heated portions of the internal combustion engine.

Since the thermoelectric device directly converts the waste heat energy from the internal combustion engine into electricity and then utilizes this electricity in the electrical system of the vehicle, enhanced efficiency of the hybrid automotive vehicle is achieved.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a block diagrammatic view of the electrical components of a preferred embodiment of the invention;

FIG. 2 is a front elevational view of a preferred embodiment of the invention; and

FIG. 3 is a front diagrammatic view of a preferred embodiment of the invention.

### DETAILED DESCRIPTION OF A PREFERRED EMBODIMENT OF THE PRESENT INVENTION

With reference first to FIG. 2, a hybrid automotive vehicle 10 is there shown diagrammatically. The vehicle 10 includes both an internal combustion engine 12 as well as an electric motor 14 used to propel the vehicle 10. An electrical system 15 controls not only the operation of both the internal combustion engine 12, but also the electric motor 14 as well as the other electrical systems of the vehicle 10.

The internal combustion engine 12 is conventional in construction and combusts fuel, such as gasoline. Heat from the combustion of the fuel is exhausted not only through an exhaust system 16 for the vehicle 10 but also radiated and convected outwardly from the engine 12. Additionally, a hood 18 overlies the internal combustion engine 12. This hood 18, when open, provides access to the engine 12 for maintenance, service, repair, etc.

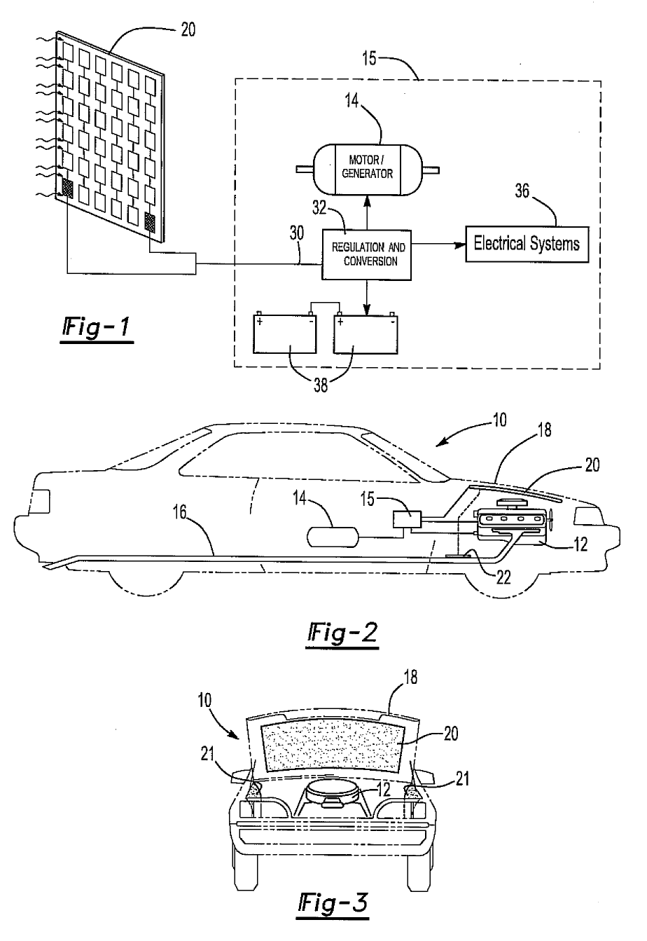

With reference now to FIGS. 1-3, a thermoelectric device 20 is disposed within the vehicle 10 so that the thermoelectric device 20 overlies at least a portion of the internal combustion engine 12. This thermoelectric device 20 converts heat energy directly into electricity. The thermoelectric device 20 may comprise, for example, one or more thermocouples or semiconductor thermophotovoltaic cells. Additionally, these thermophotovoltaic cells and/or thermocouples are preferably arranged in a panel which forms the thermoelectric device 20.

As best shown in FIG. 3, optionally the thermoelectric device 20 includes side panels 21. The side panels 21, together with the portion of the thermoelectric device 20 mounted to the hood 18, at least partially encapsulate the engine 12.

As best shown in FIG. 2, optionally a portion 22 of the thermoelectric device 20 is positioned closely adjacent a portion of the exhaust system 16. As such, this portion 22 of the thermoelectric device 20 is thermally coupled to the exhaust system 16 and generates electricity from the heat energy of the exhaust system 16. The generated electricity is electrically coupled to the vehicle electrical system.

With reference now to FIG. 1, a block diagrammatic view of the thermoelectric device 20 and an exemplary electrical system 15 is illustrated. The thermoelectric device 20, illustrated as a panel of thermocouples or semiconductor thermophotovoltaic cells, is electrically connected by wires 30 to a regulation and conversion circuit 32. The regulation and conversion circuit 32 optionally and/or alternatively provides power to the electric motor 14 to propel the vehicle. Similarly, the regulation and conversion circuit 32 is optionally and/or alternatively connected to one or more electrical storage devices 38 as well as other electrical or electronic systems 36 of the vehicle 10.

In operation, the thermoelectric device 20 captures the waste heat from the internal combustion engine 12 and converts that heat energy directly into electricity. That electricity is electrically connected to the electrical system 15 of the vehicle and stored and/or used in dependence upon the vehicle electrical requirements. Consequently, it can be seen that the present invention improves the overall efficiency of the vehicle 10 by recapturing and reusing the heat energy from the internal combustion engine 12 which would otherwise be exhausted to the atmosphere.

Having described our invention, however, many modifications will become apparent thereto without deviation from the spirit of the invention as defined by the scope of the appended claims.

We claim:

1. A hybrid automotive vehicle comprising:
an internal combustion engine,
an electrical system,
a thermoelectric device overlying said internal combustion engine, said thermoelectric device having an electrical output electrically connected to said electrical system.

2. The invention as defined in claim 1 wherein said thermoelectric device comprises at least one semiconductor thermophotovoltaic cell.

3. The invention as defined in claim 2 and comprising a plurality of thermophotovoltaic cells arranged in a panel.

4. The invention as defined in claim 1 wherein said thermoelectric device comprises a thermocouple.

5. The invention as defined in claim 4 and comprising a plurality of thermocouples arranged in a panel.

6. The invention as defined in claim 1 wherein said electrical system comprises an electrical energy storage device.

7. The invention as defined in claim 6 wherein said storage device comprises a battery.

8. The invention as defined in claim 6 wherein said storage device comprises a fuel cell.

9. The invention as defined in claim 1 wherein said electrical system comprises an electric motor.

10. The invention as defined in claim 1 and comprising a hood overlying said internal combustion motor and wherein said thermoelectric device is mounted to said hood.

11. The invention as defined in claim 10 wherein said thermoelectric device comprises side panels disposed around the sides of said motor.

12. The invention as defined in claim 1 wherein the vehicle includes an exhaust system and wherein at least a portion of the thermoelectric device is positioned adjacent said exhaust system.
